(19) United States
(12) Patent Application Publication
(10) Pub. No.: US 2015/0294687 A1
(43) Pub. Date: Oct. 15, 2015

(54) Automatic Transitions, Wipes and Fades, In A Common Video Recording/Playback Device

(71) Applicant: Hipstamatic, LLC, San Francisco, CA (US)

(72) Inventors: Lucas Buick, San Francisco, CA (US); Ryan Dorshorst, San Francisco, CA (US); Aravind Kaimal, San Francisco, CA (US)

(73) Assignee: Hipstamatic, LLC, San Francisco, CA (US)

(21) Appl. No.: 14/251,029

(22) Filed: Apr. 11, 2014

(51) Int. Cl. G11B 27/036; H04N 5/262; H04N 5/272; G11B 27/00

(52) U.S. Cl. CPC G11B 27/036; G11B 27/005; H04N 5/2628; H04N 5/272

(57) ABSTRACT

Systems and algorithms for inserting transitions (wipes and fades) into segments of recorded video are described. Automatic insertion of transitions into video makes video more beautiful and interesting, and also eliminates the need for user intervention, saving the user time. Additionally described are custom/proprietary wipe and fade effects (transitions) that are inserted. These effects include but are not limited to the categories: Through solid color or image, Bring back previous User Footage, Sequence of Images Overlay, Random Images Overlay, Mirroring User Footage, Reversing User Footage, Current Location Integration, and Blurring User Footage. Any combination of one or all of these categories of transition can be used simultaneously and combined to achieve the desired final transition that is applied to user footage. Insertion of these effects into video is based on random and temporal algorithms.

### TECHNICAL FIELD OF THE INVENTION

The present invention relates generally to systems and apparatus for video recording and playback.

### BACKGROUND OF THE INVENTION

Video, without effects, can be boring and dull. To make a beautifully edited video takes time, effort and the right digital tools. The present invention was created to allow a user to create more aesthetically appealing videos for users by streamlining the creative process for the user.

It is currently possible for a user to take video clips and to add effects before or after shooting the video. Standard operating systems (“SOS”), hardware and software for mobile devices allow users to record segments of video clips that can be automatically combined by SOS, hardware and software to create a seamless video for the end-user. Certain software applications such as Instagram allow users to add a filter effect to the video before or after recording. The addition of these effects is one consistent overlay of one effect (e.g., color-graded such as sepia) over the entire video.

This invention, which provides an improvement over existing video recording and playback software applications, allows a user to shoot video using a process similar to that as described above but with additional effects added to the video based upon the length of the segments, number of segments to be combined, the location of the segments, and the subject of the video, or other factors dictated by the software's proprietary algorithms. More specifically, the software adds new effects to the combined video clips at the transition points where the segments are placed together, and also within individual video segments. The invention, therefore, makes the video recorded by the user more interesting. Moreover, the invention defines custom effects to be inserted into recorded video.

U.S. Pat. No. 8,213,774 to Relan, et al. (“Relan”) generically describes special effects being applied to layered an non-layered video streams to form layered and combined video stream output. However, Relan does not describe how and when effect transitions are applied to video recorded by a user, does not describe random or temporal algorithms for including effects, and does not disclose custom/proprietary effects to be included into video.

### SUMMARY OF THE INVENTION

The invention adds effects at transition points within a video recorded by user. The transition points can be defined by beginning and end points of video segments, or they can be defined by some other way. This invention provides the algorithms and apparatus for adding these effects to video.

The standard process for shooting video is as follows:
1. Set device to video-taking mode/open software to take video.
2. Record segments of video.
3. Standard software combines segments into one seamless video for user.
4. Add effects to video as determined by the user.
5. Choose filter on software application—if allowed.

The process for shooting video with invention is as follows:
1. Set device to video-taking mode/open software to take video.
2. Record segments of video.
3. Combines segments into one seamless video for user with effects as determined by proprietary algorithms.
4. Choose filter on software application—if allowed.

Accordingly, this invention eliminates the need for step 4 in the standard process for shooting video, because this invention describes algorithms for adding industry and custom effects to video. This invention defines such new custom effects.

The invention's software combines video segments into one video for the user, while new digital effects are added to video at the transition points where segments are combined and also within individual segments. Effects are added in part at random and in part as determined by the length of the clips, number of clips, location of clips, subject of the clips among other factors. With more interesting and enhanced transition points due to the added effects, the completed video is much more beautiful and interesting.

This new process allows users to have a much better finished product, saving users the additional step of having to add new effects in the finished video. Other known products do not process multiple clips with any variation. The primary benefit of this invention is that this invention simplifies a process for those recording video and wanting a beautiful finished product. The software makes choices for the user to add these extra effects, which end up giving the user a better product in less time.

There are no known competing alternatives other than taking a finished video using a standard process and taking the time to add the additional effects over that video by using software found within that software or using additional software. This invention additionally defines a set of custom effects that are added to the video, and describes the algorithms that dictate how the effects are included into video segments recorded by a user.

### BRIEF DESCRIPTION OF THE DRAWINGS

FIG. 1 shows the capture view of the application.

FIG. 2 shows the filter picker.

FIG. 3 shows the share options.

FIG. 4 illustrates a range of visual filters available from the filter picker.

### DETAILED DESCRIPTION OF INVENTION

The invention provides a detailed list of effects that can be added to video. In the invention's nomenclature, the effects are knows as “wipes” and/or “fades”. These wipes and fades are inserted into the video footage at transition points. Custom effects, or effects that are not already well known in the art, are also accomplished in the software.

Each effect that occurs at the intersection of two clips (“Transition”) is entirely custom and designed to go along with the overall look (“Filter”) of the finished video. There are certain categories of different types of Transitions that can occur (and it is very possible that the Transition system will be elaborated and improved to add more categories in the future). Here is a list of the current types of Transitions:
Through solid color or image. The first clip (“Initial Clip”) transitions from the footage shot (“User Footage”), by increasing the opacity of a solid color or image (an “Alpha Ramp”) until that color or image is entirely opaque and obstructing the User Footage. The solid color or image then undergoes a reverse Alpha Ramp, and the opacity gradually returns to 0% as the second clip (“Next Clip”) of User Footage appears.
Bring back previous User Footage. A randomly chosen segment is pulled from a previous clip of User Footage (neither the Initial Clip nor the Next Clip) and inserted during the Transition.
Sequence of Images Overlay. A sequence of predefined images is superimposed over the top of the User Footage, near the end of the Initial Clip and leading into the Next Clip.
Random Images Overlay. A sequence of randomly chosen images is superimposed over the top of the User Footage. Unlike the “Sequence” described above, these images are chosen at random and yields different results each time it is used.
Mirroring User Footage. A portion of the User Footage is cropped, and transformed along the horizontal or vertical axis before being superimposed on top of the original User Footage.
Reversing User Footage. A portion of the User Footage found at the end of the Initial Clip or beginning of the Next Clip is reversed. This means that the order of the individual frames of the footage is flipped, giving the appearance that the video is going backwards. (In a 10 frame Transition, frame 1 becomes frame 10, frame 2 becomes frame 9, and so on).
Current Location Integration. The location that the User Footage was shot in is superimposed over the top of the User Footage.
Blurring User Footage. A portion of the User Footage is blurred. This footage

(“Blurred Footage”) can then be superimposed over the top of existing footage, and can also have the blurriness (“Blur Radius”) ramped between two different values. For example, the Initial Clip could begin without any blurring, and the footage could become more blurry (by increasing the Blur Radius) as the Initial Clip ends. The Next Clip could begin as blurry (with a high Blur Radius), and have that blurriness reduced until it is no longer present as the Transition completes.

Any combination of one or all of the above categories of Transition can be used simultaneously and combined by our invention to achieve the desired final Transition that is applied to User Footage. Other Effects could be based on speedup or slowdown of video, or incorporate audio. In addition, some Effects define that a random selection of one or more of the above types of Transitions be applied between the Initial Clip and the Next Clip, which yields different results each time the invention is used.

Additionally, there are other parameters of the above defined Transitions that can randomly change each time they are used. For example, in one Through Solid Color Transition, it is possible that the first time it is applied the Alpha Ramp goes from 0% to 100% and then back to 0% (between the Initial Clip and the Next Clip). The next time the Transition is applied, it is possible that it randomly does the Alpha Ramp from 0% to 85% and then back to 0% (which would give the result of not having the Solid Color becoming completely opaque at the height of the transition, but instead the user still being able to see translucent User Footage through the Solid Color).

Finally, in addition to Transition events occasionally more effects (using the same systems described above, referred to as “Additional Special Effects”) are superimposed in the middle of User Footage.

The algorithms that are used to select each effect are as follows. Effects are selected in part based on the length (of time) of individual user clips. The parameters describing the minimum clip length for Additional Special Effects vary for each Effect. Here is an example of an Additional Special Effect that can be applied if a clip is at least 3 seconds in length:

if (ClipOne.length > 3.seconds) {
applyAdditionalSpecialEffect( )
}

Additionally, some effects are selected purely at random. Even in this case different effects have different thresholds for when they are applied. In other words, some effects are more “rare” than others.

```
randomNumber = GenerateRandomNumberBetween1and10( );
if (randomNumber > 5) {
  applyCommonSpecialEffect( )
}
if (randomNumber > 9) {
  applyRareSpecialEffect( )
}
```

This randomness algorithm plays a large part in making sure each final clip that gets generated is unique. The randomness itself occurs through a simple random number generator (which is a very common coding utility), and based on the values it returns the software picks different places to insert different clips.

For example, lets say we have Effect A, Effect B, and Effect C, and the User Footage is comprised of 3 clips: Clip One is 5 seconds, Clip Two is 3 seconds, and Clip Three is 10 seconds. The given randomness algorithm for Effect A states that it is fairly common—it occurs 50% of the time; and should occur in clips that are greater than 4 seconds in length. Therefore Clip Two is immediately ruled out as ineligible for Effect A (it is too short), however Clips One and Three are eligible. We tell our Random Number Generator to generate a decimal number between 0 and 1, and to do this two times. (The Random Number generator is a bit like dice—in this case it's a two-sided die and we “roll” it twice).

Let's say the first roll gets us a value of 0.35. Since this is less than 0.5, we then conclude that Clip One is (randomly) ineligible for Effect A, and do not apply it. However lets say roll two gives us a value of 0.8. Since this is greater than 0.5, we then conclude that Clip Three is eligible for Effect A, and continue on to the next step of applying it.

At this point we introduce one more element of randomness—determining when exactly to apply the effect. Let's say Effect A is 2 seconds in length. Since Clip Three is 10 seconds in length, there are a number of different spots we can apply it. We take the range of available starting times (by taking the Clip Duration and subtracting it from the Effect Duration—10 minus 2) which gives us 8. We then use our Random Number Generator again and ask for a number between 0 and 8. Let's say it gives us a value of 6.5.

We now have all the information needed to apply Effect A—it is set to be applied on Clip Three, from timestamp 6.5 seconds through 8.5 seconds. We would then go on to Effect B and Effect C, and given their parameters (“rarity” and “minimum duration”) repeat the above process again.

It is the actual implementations of the categories of Effects that are common or rare. Individual effects can be more or less rare, depending on the final visual effect we are looking to achieve.

As an example, a Rarity of 0.5 means the effect should be applied 50% of the time. A Rarity of 0.8 means a very common effect—applied 80% of the time, or a Rarity of 0.2 would mean a very rare effect—only applied 20% of the time.

The values we choose for rarity are based on the creative goals for a given effect, but generally effects that are more impacting are more rare. As a contrived example, a given effect that makes the entire screen bright green for 2 seconds might be set to 0.1 Rarity, so that it doesn't happen very often (since it is such a massive visual change from the User Footage). However an effect that adds a tiny sepia tint to User Footage might be set to 0.8 Rarity, so that it happens fairly often (since it involves much less jarring, minimal change to the User Footage).

Apple's Developer Tools (the iOS Software Development Kit) can be used to create the implementation of this invention on iOS. However other tools could be used to replicate the invention on other platforms (such as Android).

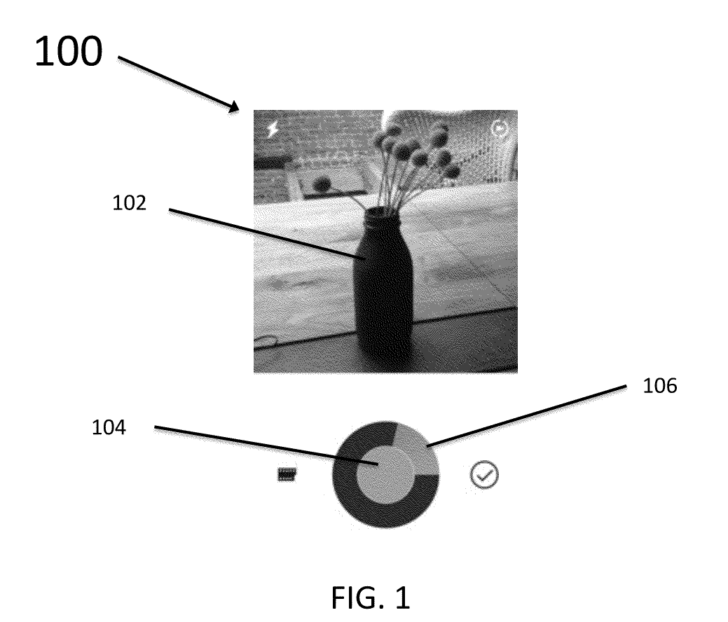

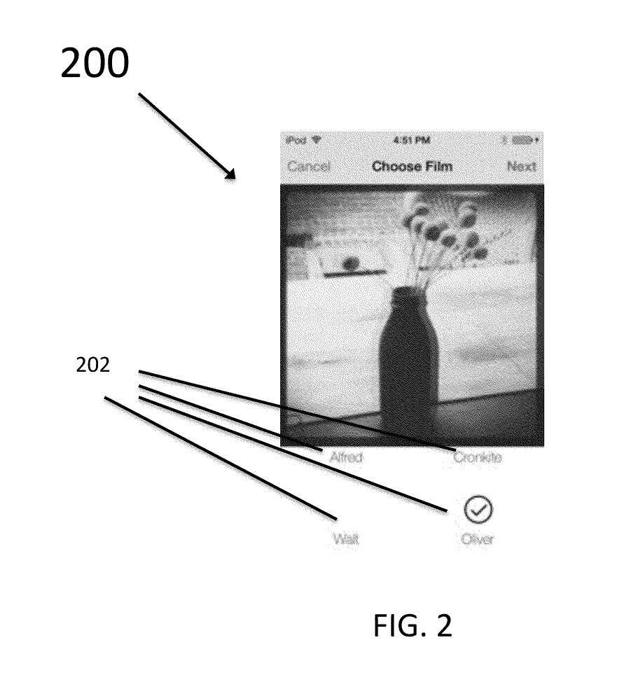

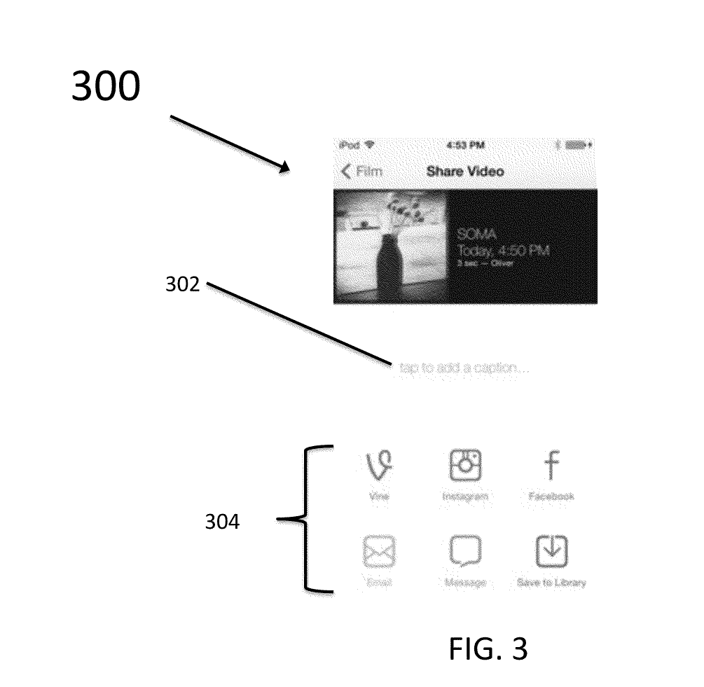

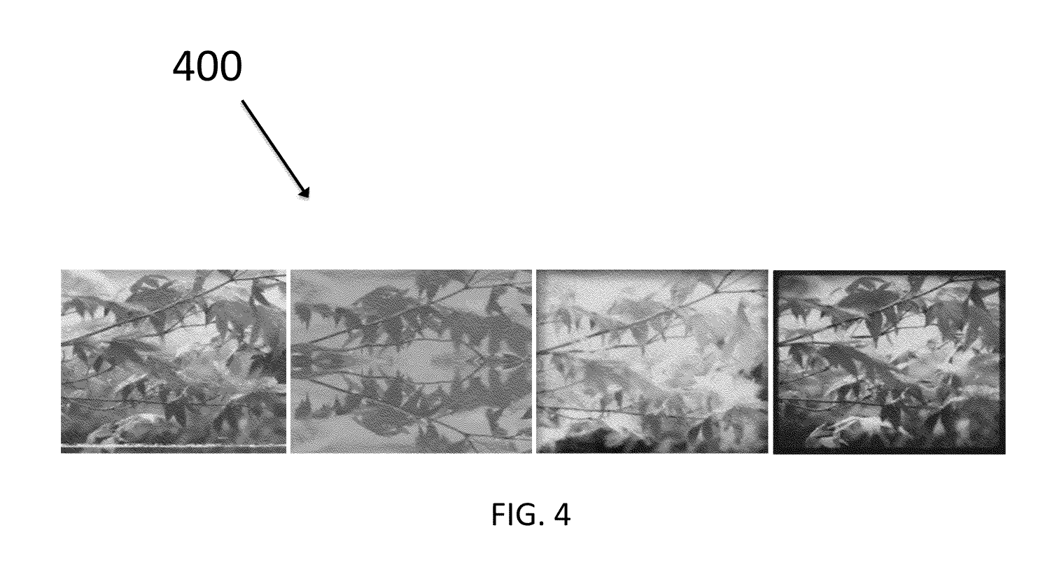

The drawings are screen shots from the iOS app. FIG. 1 is the Capture view screen 100, where the user captures one or more clips of User Footage. The Capture view screen 100 consists of a display 102, a virtual button 104, and a progress bar 106. FIG. 2 is the Effect Picker screen 200, where a user chooses the Effect for the footage captured in screen one. In this example four effect options 202 are provided: Alfred, Cronkite, Walt and Oliver, with Oliver selected. FIG. 3 is the Share options screen 300, where the user chooses what to do with the movie after the invention has applied the Effect (including Transitions and Additional Special Effects) to the User Footage. The user can optionally add a caption 302, and have several post-application options 304, in this example including Vine, Instagram, Facebook, Email, Message, and Save to Library. Other possibilities include exporting the finished movie to a cloud or market. FIG. 4 illustrates the different visual filters 400 available from the Filter Package. The filter picker is the single point of user interaction in our invention—it is where the user picks the overall Filter Package they want for their User Footage. A given Filter Package encompasses the Base Effect (color grading or textures that are superimposed over the entire clip), the Transitions, and the additional Random Special Effects that are applied. New Filter Packages can be released throughout the lifetime of a product incorporating aspects of the invention, which is where the element of new and different methods of generating Effects will come into play.

It will be appreciated that the above description is of a video effects processing system that operates on the very same platform (in this case a mobile phone with camera features) that the user employs to take the raw video footage and clips. It will also be appreciated that the platform contains a processor that executes the algorithms described above to generate the effects at transitions between video clips and within clips.

While the above specification and examples provide a description of the invention, many embodiments of the invention can be made without departing from the spirit and scope of the invention. It is to be understood that the foregoing embodiments are provided as illustrative only, and does not limit or define the scope of the invention. Various other embodiments are also within the scope of the claims.

What is claimed is:

1. A video recording, playback and editing device comprising:
in one housing: a video recording camera;
a screen for displaying video clips recorded by the camera; and
a processor configured to execute an algorithm that combines video clips into one video movie, the video movie consisting of the video clips sequenced together with transitions automatically placed within and between them upon user indication that all video clips for a video movie are complete, wherein the transitions comprise randomly selected effects that are chosen without user interaction.

2. The device of claim 1, wherein the randomly selected effects include one or more from the list comprising:
i. a first clip of video transitioning by an alpha ramp, increasing the opacity of a solid color image until that color or image is entirely opaque and obstructing the clip, and wherein the solid color or image undergoes a reverse alpha ramp, with the opacity gradually returning to 0% as a second clip of video appears;
ii. randomly chosen video previously recorded by a user;
iii. a sequence of predefined images superimposed over the top of the video, near the end of an initial video clip and leading into a next video clip;
iv. a sequence of randomly chosen images superimposed over the top of the video movie;
v. a crop of a portion of a video clip, the cropped portion transformed along the horizontal or vertical axis, effecting a mirror image, before being superimposed on top of the video movie;
vi. a reversal of the video movie, such that a portion of the video found at the end of a video clip or beginning of a subsequent video clip is reversed, by flipping the order of the individual frames, giving the appearance that the video movie is going backwards during playback;
vii. superimposing the location of a user recording the video clips over the top of the video movie;
viii. superimposing a blurred portion of a video clip over the top of the video movie, wherein the blurriness can be ramped between two different values, by increasing the blurriness during the recording or reducing the blurriness during recording, or both;
ix. speeding up a portion of the video movie; or
x. slowing down a portion of the video movie.

3. The device of claim 1, wherein the processor is further configured to allow the user to select an overall filter package, selecting color grading or textures that are superimposed over the entire video movie.

4. The device of claim 1, wherein the processor is further configured to enable transfer of the completed video movie to one or more of a social networking, file, photo, or movie sharing platform, market, email, message, cloud, or library.

5. The device of claim 1, wherein the randomness of the effects includes deciding when to apply an effect within the video movie.

6. The device of claim 1, wherein the randomness of the effects includes deciding how often a particular effect is applied within the video movie.

7. A video recording, playback and editing device comprising:
in one housing: a video recording camera;
a screen for displaying video clips recorded by the camera; and
a processor configured to execute an algorithm that combines video clips into one video movie, the video movie consisting of the video clips sequenced together with transitions automatically placed within and between them upon user indication that all video clips for a video movie are complete, wherein the transitions comprise added effects layered over based on clip length without user interaction.

8. The device of claim 7, wherein the added effects layered over include one or more from the list comprising:
i. a first clip of video transitioning by an alpha ramp, increasing the opacity of a solid color image until that color or image is entirely opaque and obstructing the clip, and wherein the solid color or image undergoes a reverse alpha ramp, with the opacity gradually returning to 0% as a second clip of video appears;
ii. randomly chosen video previously recorded by a user;
iii. a sequence of predefined images superimposed over the top of the video, near the end of an initial video clip and leading into a next video clip;
iv. a sequence of randomly chosen images superimposed over the top of the video movie;
v. a crop of a portion of a video clip, the cropped portion transformed along the horizontal or vertical axis, effecting a mirror image, before being superimposed on top of the video movie;
vi. a reversal of the video movie, such that a portion of the video found at the end of a video clip or beginning of a subsequent video clip is reversed, by flipping the order of the individual frames, giving the appearance that the video movie is going backwards during playback;
vii. superimposing the location of a user recording the video clips over the top of the video movie;
viii. superimposing a blurred portion of a video clip over the top of the video movie, wherein the blurriness can be ramped between two different values, by increasing the blurriness during the recording or reducing the blurriness during recording, or both; speeding up or slowing down a portion of the video movie;
ix. speeding up a portion of the video movie; or
x. slowing down a portion of the video movie.

9. The device of claim 7, wherein the processor is further configured to allow the user to select an overall filter package, selecting color grading or textures that are superimposed over the entire video movie.

10. The device of claim 7, wherein the processor is further configured to enable transfer of the completed video movie to one or more of a social networking, file, photo, or movie sharing platform, market, email, message, cloud, or library.

11. A process comprising:
recording, by a user of a device, video clips;
displaying, by the device, video clips recorded by the user; and
executing, by a processor within the device, an algorithm that combines the video clips into one video movie, the video movie consisting of the video clips sequenced together with transitions automatically placed within and between them upon user indication that all video clips for a video movie are complete, wherein the transitions comprise randomly selected effects that are chosen without user interaction.

12. The process of claim 11, wherein the randomly selected effects include one or more from the list comprising:
i. a first clip of video transitioning by an alpha ramp, increasing the opacity of a solid color image until that color or image is entirely opaque and obstructing the clip, and wherein the solid color or image undergoes a reverse alpha ramp, with the opacity gradually returning to 0% as a second clip of video appears;
ii. randomly chosen video previously recorded by a user;
iii. a sequence of predefined images superimposed over the top of the video, near the end of an initial video clip and leading into a next video clip;
iv. a sequence of randomly chosen images superimposed over the top of the video movie;
v. a crop of a portion of a video clip, the cropped portion transformed along the horizontal or vertical axis, effecting a mirror image, before being superimposed on top of the video movie;
vi. a reversal of the video movie, such that a portion of the video found at the end of a video clip or beginning of a subsequent video clip is reversed, by flipping the order of the individual frames, giving the appearance that the video movie is going backwards during playback;
vii. superimposing the location of a user recording the video clips over the top of the video movie;
viii. superimposing a blurred portion of a video clip over the top of the video movie, wherein the blurriness can be ramped between two different values, by increasing the blurriness during the recording or reducing the blurriness during recording, or both; speeding up or slowing down a portion of the video movie;
ix. speeding up or slowing down a portion of the video movie; or
x. slowing down a portion of the video movie.

13. The process of claim 11, wherein the processor is further configured to allow the user to select an overall filter package, selecting color grading or textures that are superimposed over the entire video movie.

14. The process of claim 11, wherein the processor is further configured to enable transfer of the completed video movie to one or more of a social networking, file, photo, or movie sharing platform, market, email, message, cloud, or library.

15. The process of claim 11, wherein the randomness of the effects includes deciding when to apply an effect within the video movie.

16. The device of claim 11, wherein the randomness of the effects includes deciding how often a particular effect is applied within the video movie.

17. A process comprising:
recording, by a user of a device, video clips;
displaying, by the device, video clips recorded by the user; and
executing, by a processor within the device, an algorithm that combines the video clips into one video movie, the video movie consisting of the video clips sequenced together with transitions automatically placed within and between them upon user indication that all video clips for a video movie are complete, wherein the transitions comprise added effects layered over based on clip length without user interaction.

18. The process of claim 17, wherein the added effects layered over include one or more from the list comprising:
i. a first clip of video transitioning by an alpha ramp, increasing the opacity of a solid color image until that color or image is entirely opaque and obstructing the clip, and wherein the solid color or image undergoes a reverse alpha ramp, with the opacity gradually returning to 0% as a second clip of video appears;
ii. randomly chosen video previously recorded by a user;
iii. a sequence of predefined images superimposed over the top of the video, near the end of an initial video clip and leading into a next video clip;
iv. a sequence of randomly chosen images superimposed over the top of the video movie;
v. a crop of a portion of a video clip, the cropped portion transformed along the horizontal or vertical axis, effecting a mirror image, before being superimposed on top of the video movie;
vi. a reversal of the video movie, such that a portion of the video found at the end of a video clip or beginning of a subsequent video clip is reversed, by flipping the order of the individual frames, giving the appearance that the video movie is going backwards during playback;
vii. superimposing the location of a user recording the video clips over the top of the video movie;
viii. superimposing a blurred portion of a video clip over the top of the video movie, wherein the blurriness can be ramped between two different values, by increasing the blurriness during the recording or reducing the blurriness during recording, or both; speeding up or slowing down a portion of the video movie;
ix. speeding up a portion of the video movie; or
x. slowing down a portion of the video movie.

19. The process of claim 17, wherein the processor is further configured to allow the user to select an overall filter package, selecting color grading or textures that are superimposed over the entire video movie.

20. The process of claim 17, wherein the processor is further configured to enable transfer of the completed video movie to one or more of a social networking, file, photo, or movie sharing platform, market, email, message, cloud, or library.
